(19) United States
(12) Patent Application Publication
(10) Pub. No.: US 2004/0131900 A1
(43) Pub. Date: Jul. 8, 2004

(54) Fuel cell system and method of operating the same

(75) Inventors: Joseph Cargnelli, Toronto (CA); Todd A. Simpson, Brampton (CA); Stephen Burany, Thornhill (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Hydrogenics Corporation, Mississauga (CA)

(21) Appl. No.: 10/667,898

(22) Filed: Sep. 23, 2003

Related U.S. Application Data
(60) Provisional application No. 60/412,588, filed on Sep. 23, 2002.

(51) Int. Cl. H01M 8/00; H01M 8/12

(52) U.S. Cl. 429/13; 429/22

(57) ABSTRACT

A fuel cell system and a method of operating same. The fuel cell system comprises a fuel cell for driving a load, a first process delivery device for supplying a first process fluid to the fuel cell, and a controller for controlling an operation rate of the first process fluid delivery device based on an overriding signal received from a signal source external to the controller and the fuel cell.

### FIELD OF THE INVENTION

The present invention relates generally to a fuel cell system. More particularly, the present invention relates to a method of operating a fuel cell system for large load transient.

### BACKGROUND OF THE INVENTION

Fuel cell systems are seen as a promising alternative to traditional power generation technologies due to their low emissions, high efficiency and ease of operation. Fuel cells operate to convert chemical energy into electrical energy Proton exchange membrane fuel cells comprise an anode, a cathode, and a selective electrolytic membrane disposed between the two electrodes. In a catalyzed reaction, a fuel such as hydrogen, is oxidized at the anode to form cations (protons) and electrons. The ion exchange membrane facilitates the migration of protons from the anode to the cathode. The electrons cannot pass through the membrane and are forced to flow through an external circuit thus providing an electrical current. At the cathode, oxygen reacts at the catalyst layer, with electrons returned from the electrical circuit, to form anions. The anions formed at the cathode react with the protons that have crossed the membrane to form liquid water as the reaction product

Proton exchange membranes require a wet surface to facilitate the conduction of protons from the anode to the cathode, and otherwise to maintain the membranes electrically conductive. It has been suggested that each proton that moves through the membrane drags at least two or three water molecules with it (U.S. Pat. No. 5,996,976). U.S. Pat. No. 5,786,104 describes in qualitative terms a mechanism termed “water pumping”, involving the transport of cations (protons) with water molecules through the membrane. As the current density increases, the number of water molecules moved through the membrane also increases. Eventually the flux of water being pulled through the membrane by the proton flux exceeds the rate at which water is replenished by diffusion. At this point the membrane begins to dry out, at least on the anode side, and its internal resistance increases. It will be appreciated that this mechanism drives water to the cathode side, and additionally the water created by reaction is formed at the cathode side. Nonetheless, it is possible for the flow of gas across the cathode side to be sufficient to remove this water, resulting in drying out on the cathode side as well. To maintain membrane conductivity, the surface of the membrane must remain moist at all times. Therefore, to ensure adequate efficiency, the process gases must be, on entering the fuel cell, at an appropriate humidity and at a suitable temperature for keeping the membrane moist. The range for suitable humidities and temperatures will depend on system requirements.

A further consideration is that there is an increasing interest in using fuel cells in transport and like applications, e.g. as the basic power source for cars, buses and even larger vehicles. Automotive applications are quite different from many stationary applications. For example in stationary applications, fuel cell stacks are commonly used as an electrical power source and are simply expected to run at a relatively constant power level for an extended period of time. In contrast, in an automotive environment, the actual power required from the fuel cell stack can vary widely. Additionally, the fuel cell stack supply unit is expected to respond rapidly TO changes in power demand, whether these be demands for increased or reduced power, while maintaining high efficiencies. Further, for automotive applications, a fuel cell power unit is expected to operate under an extreme range of ambient temperature and humidity conditions.

All of these requirement are exceedingly demanding and make it difficult to ensure a fuel cell stack will operate efficiently under all of the possible operating conditions. Meeting these requirements depends on maintaining effective control over the fuel cell operating conditions.

Accordingly, there remains a need for a fuel cell gas management system that can offer rapid dynamic control of fuel cell op rating conditions.

### SUMMARY OF THE INVENTION

While many different operational parameters of the fuel cell system can advantageously be changed based on the operating level of the fuel system, few, if any, are more important than the rate at which the incoming fuel cell process gases are supplied. That is, if the operating level of a fuel cell system increases significantly without more fuel cell process gases being supplied, then this will have a rapid deleterious affect on the operation and efficiency. Further, the operating lifetime of the fuel cell system will be significantly reduced

At the same time, it is important for efficiency reasons that the parasitic load placed on the fuel cell system by the process fluid delivery device be minimized. Thus, the process fluid delivery devices should not provide an oversupply of the process fluids when the fuel cell is operating at a low level.

In accordance with an aspect of the present invention, there is provided a fuel cell system comprising: (a) a fuel cell for driving a load; (b) a first process fluid delivery device for supplying a first process fluid to the fuel cell; (c) a controller for controlling an operation rate of at least the first process fluid delivery device; and, (d) a signal source external to the controller, for providing a signal to the controller to change the operation rate of at least the first process fluid delivery device.

In accordance with a second aspect of the present invention, there is provided a method of operating a fuel cell system. The method comprises (a) supplying a process fluid to a fuel cell at a supply rate; (b) driving a load using the fuel cell; (c) measuring at least one of a first value representing a current in the load and a second value representing a rate of change of the current in the load; and, (d) changing the supply rate based on at least one of the first value and the second value.

### BRIEF DESCRIPTION OF THE DRAWINGS

For a better understanding of the present invention, and to show more clearly how it may be carried into effect, reference will now be made, by way of example, to the accompanying drawings, which show a preferred embodiment of the present invention and in which:

FIG. 1 illustrates a schematic flow diagram of a first embodiment of a fuel cell gas and water management system according to the present invention;

FIG. 1b, in a block diagram, illustrates a controller of the fuel cell gas and water management system of FIG. 1;

FIG. 2, in a schematic flow diagram, illustrates a second embodiment of a fuel cell gas and water management system to which aspects of the present invention may be applied;

FIG. 3, in a partial schematic flow diagram, illustrates a third embodiment of a fuel cell gas and water management system, which operates under high pressure, to which aspects of the present invention may be applied;

FIG. 4, in a partial schematic flow diagram, illustrates a fourth embodiment of a fuel cell gas and water management system to which aspects of the present invention may be applied;

FIGS. 5a and 5b, in partial schematic flow diagrams, illustrate the connection of two regenerative dryer devices of a fuel cell gas and water management system to which aspects of the present invention may be applied; and

FIG. 6, in a partial schematic flow diagram, illustrates a pressure balancing mechanism of a fuel cell gas and water management system to which aspects of the present invention may be applied.

### DETAILED DESCRIPTION OF THE INVENTION

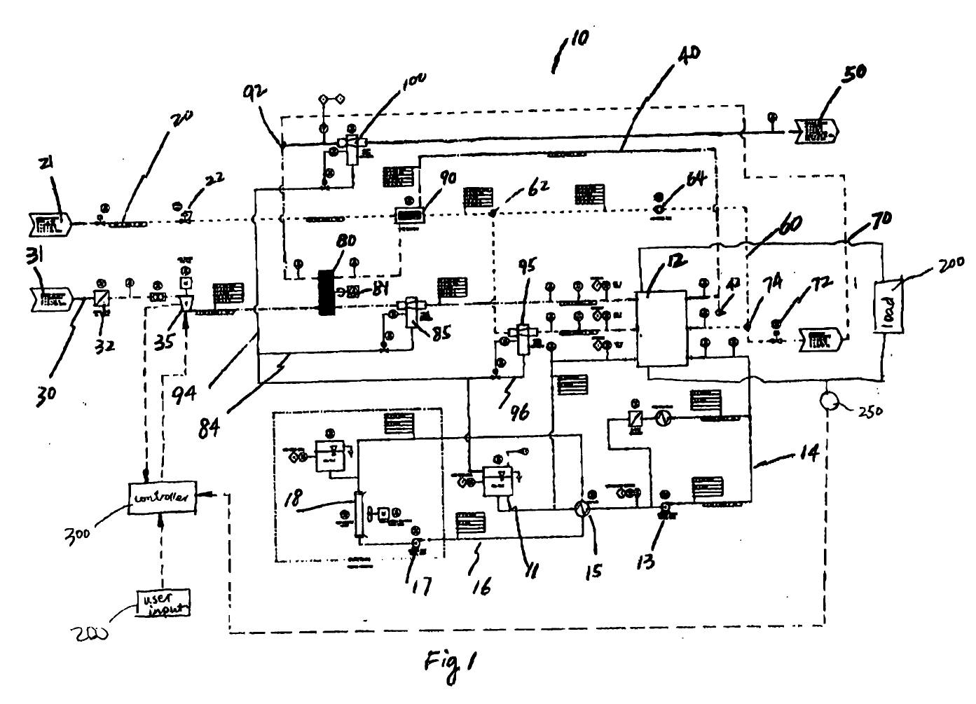

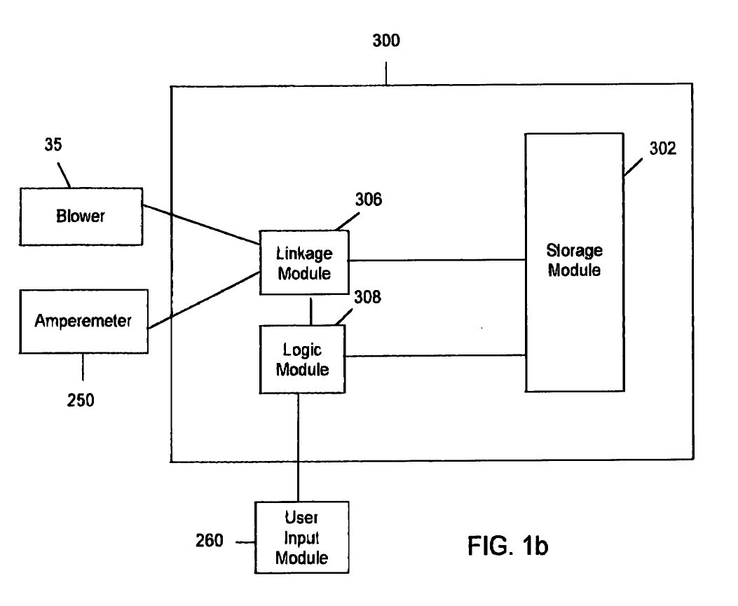

Referring first to FIG. 1, there is illustrated a schematic flow diagram of a first embodiment of a fuel cell gas management system 10 according to the present invention. The fuel cell gas management system 10 comprises a fuel supply line 20, an oxidant supply line 30, a cathode exhaust recirculation line 40 and an anode exhaust recirculation line 60, all connected to a fuel cell 12. It is to be understood that the fuel cell 12 may comprise a plurality of fuel cells (a fuel cell stack) or just a single fuel cell. For simplicity, the fuel cell 12 described herein operates on hydrogen as fuel and air as oxidant and can be a Proton Exchange Membrane (PEM) fuel cell. However, the present invention is not limited to this type of fuel cell and is applicable to other types of fuel cells that rely on other fuels and oxidants.

The fuel supply line 20 is connected to a fuel source 21 for supplying hydrogen to the anode of the fuel cell 12. A hydrogen humidifier 90 is disposed in the fuel supply line 20 upstream from the fuel cell 12 and an anode water separator 95 is disposed between the hydrogen humidifier 90 and the fuel cell 12. The oxidant supply line 30 is connected to an oxidant source 31, e.g. ambient air, for supplying air to the cathode of the fuel cell 12. A regenerative dryer 80 is disposed in the oxidant supply line 30 upstream of the fuel cell 12 and also in the cathode recirculation line 40. A cathode water separator 85 is disposed between the regenerative dryer 80 and the fuel cell 12. The regenerative dryer 80 can comprise porous materials with a desiccant and may be any commercially available dryer suitable for fuel cell system. The regenerative dryer 80 has a switch means to allow gases from the oxidant supply line 30 and the oxidant recirculation line 40 to alternately pass through the regenerative dryer 80 to exchange heat and humidity. Dry ambient air enters the oxidant supply line 30 and first passes through an air filter 32 that filters out any impurity particles. A blower 35 is disposed upstream of the regenerative dryer 80, to draw air from the air filter 32 and to pass the air through the regenerative dryer 80.

A fuel cell cathode exhaust stream contains excess air, product water and water transported from the anode side, the air being nitrogen rich due to consumption of at least part of the oxygen in the fuel cell 12. The cathode exhaust stream is recirculated through the cathode exhaust recirculation line 40 connected to the cathode outlet of the fuel cell 12. The humid cathode exhaust stream first passes through the hydrogen humidifier 90 in which the heat and humidity is transferred to incoming dry hydrogen in the fuel supply line 20. The hydrogen humidifier 90 can be any suitable humidifier, such as that commercially available from Perma Pure Inc, Toms River, N.J. It may also be a membrane humidifier and other types of humidifier with either high or low saturation efficiency. In fact, the hydrogen humidifier 90 is also a regenerative dryer, however, in view of the different gases in the anode and cathode streams, regenerative dryers or other devices that permit significant heat mass interchange between the two streams cannot be used.

From the hydrogen humidifier 90, the fuel cell cathode exhaust stream continues to flow along the recirculation line 40 and passes through the regenerative dryer 80, as mentioned above. As the humid cathode exhaust passes through the regenerative dryer 80, the heat and moisture is retained in the porous paper or fiber material of the regenerative dryer 80. After the porous paper or fiber material of the regenerative dryer 80 has been humidified by the humid cathode exhaust pressing therethrough, the switch means of the regenerative dryer 80 switches the connection of the regenerative dryer 80 from the cathode exhaust stream to the incoming air stream, and the humidity retained in the porous paper or fiber material of the regenerative dryer 80 is then transferred to the incoming dry air stream passing through the regenerative dryer 80 in the oxidant supply line 30. Concurrently the cathode exhaust stream continues to flow along the recirculation line 40 to an exhaust water separator 100 in which the excess water, again in liquid form, that has not been transferred to the incoming hydrogen and air streams is separated from the exhaust stream. Then the exhaust stream is discharged to the environment along a discharge line 50.

A cathode outlet drain line 42 may optionally be provided in the recirculation line 40 adjacent the cathode outlet of the fuel cell to drain out any liquid water remaining or condensed out. The cathode outlet drain line 42 may be suitably sized so that gas bubbles in the drain line actually retain the water in the cathode outlet drain line and automatically drain water on a substantially regular basis, thereby avoiding the need of a drain valve that is commonly used in the field to drain water out of gas stream. Such a drain line can be used anywhere in the system where liquid water needs to be drained out from gas streams.

The humidified hydrogen from the hydrogen humidifier 90 flows along the fuel supply line 20 to the anode water separator 95 in which excess water is separated before the hydrogen enters the fuel cell 12. Likewise, the humidified air from the regenerative dryer 80 flows along the oxidant supply line 30 to the cathode water separator 85 in which excess liquid water is separated before the air enters the fuel cell 12.

Fuel cell anode exhaust comprising excess hydrogen and water is recirculated by a recirculation pump 64 along the anode recirculation line 60 connected to the anode outlet of the fuel cell 12. The anode recirculation line 60 connects to the fuel supply line 20 at a first joint 62 upstream from the anode water separator 95. The recirculation of the excess hydrogen together with water vapor not only permits utilization of hydrogen to the greatest possible extent and prevents liquid water from blocking hydrogen reactant delivery to the reactant sites, but also achieves self-humidification of the fuel stream since the water vapor from the recirculated hydrogen humidifies the incoming hydrogen from the hydrogen humidifier 90. This is highly desirable since this arrangement offers more flexibility in the choice of hydrogen humidifier 90 as the humidifier 90 does not then need to be a highly efficient one in the present system. By appropriately selecting the hydrogen recirculation flow rate, the required efficiency of the hydrogen humidifier 90 can be minimized- For example, supposing the fuel cell 12 needs one unit of hydrogen, hydrogen can be supplied from the hydrogen source in the amount of three units with two units of excess hydrogen recirculated together with water vapor. The speed of recirculation pump 64 may be varied to adjust the portion of recirculated hydrogen in the mixture of hydrogen downstream from the first joint 62. The selection of stoichiometry and recirculation pump 64 speed may eventually lead to the omission of the hydrogen humidifier 90.

In practice, since air is used as oxidant, it has been found that nitrogen crossover from the cathode side of the fuel cell to the anode side can occur, e.g. through the membrane of a PEM fuel cell. Therefore, the anode exhaust actually may contain some nitrogen and possibly other impurities. Recirculation of anode exhaust may result in the build-up of nitrogen and poison the full cell. Preferably, a hydrogen purge line 70 branches out from the fuel recirculation line 60 from a joint or connection 74 adjacent the fuel cell cathode outlet. A purge control device 72 is disposed in the hydrogen purge line 70 to purge a portion of the anode exhaust out of the recirculation line 60 The frequency and flow rate of the purge operation is dependent on the power at which the fuel cell 12 is running When the fuel cell 12 is running at high power, it is desirable to purge a higher portion of anode exhaust. The purge control device 72 may be a solenoid valve or other suitable device.

The hydrogen purge line 70 runs from the branch point 74 to a second or connection joint 92 at which it joins the cathode exhaust recirculation line 40. Then the mixture of purged hydrogen and the cathode exhaust from the regenerative dryer 80 passes through the exhaust water separator 100. Water is condensed in the water separator 100 and the remaining gas mixture is discharged to the environment along the discharge line 50. Alternatively, either the cathode exhaust recirculation line 40 or the purge line 70 can be connected directly into the water separator 100. It is also known to those skilled in the art that the purged hydrogen or the cathode exhaust from the regenerative dryer 80 can be separately discharged without condensing water therefrom.

Preferably, water separated by the anode water separator 95, cathode water separator 85, and the exhaust water separator 100 are not discharged, but rather the water is recovered respectively along anode inlet drain line 96, cathode inlet drain line 84 and discharge drain line 94 to a product water tank, for use in various processes.

As is known to those skilled in the art, a first cooling loop 14 runs through the fuel cell 12. A first coolant pump 13 is disposed in the first cooling loop 14 for circulating the coolant. The coolant may be any coolant commonly used in the field, such as any non-conductive water, glycol, etc. A first expansion tank 11 can be provided in known manner. A first heat exchanger 15 is provided in the first cooling loop 14 for cooling the coolant flowing through the fuel cell 12 to maintain the coolant in an appropriate temperature range.

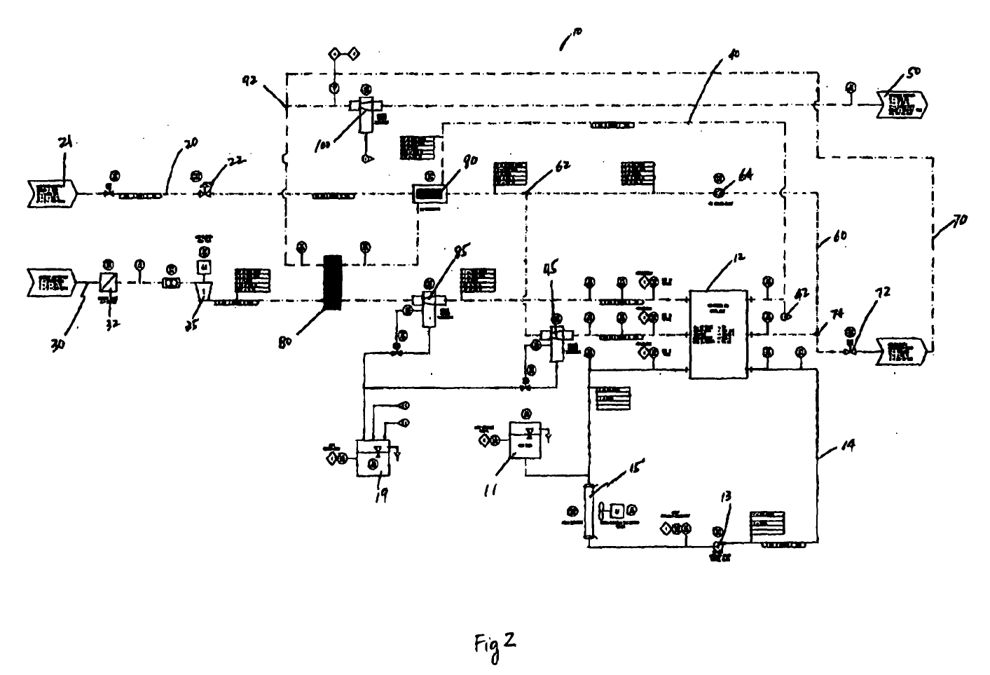

FIG. 1 shows one variant, in which a second cooling loop 16 includes a second coolant pump 17, to circulate a second coolant. A second heat exchanger 18, e.g. a radiator, is provided to maintain the temperature of the coolant in the second cooling loop and again, where required, a second tank 19 (shown in FIG. 2) is provided. The coolant in the second cooling loop 16 may be any type of coolant as the first and second cooling loops 14 and 16 do not mix. However, it is to be understood that the separate second cooling loop is not essential.

Referring to FIG. 2, there is illustrated in a schematic flow diagram an alternative fuel cell gas and water management system. In FIG. 2, components similar to the components illustrated in FIG. 1 are indicated using the same reference numerals, and for simplicity and brevity, the description of these components is not repeated. As shown in FIG. 2, a heat exchanger 15 is provided in the first cooling loop 14 to maintain the temperature of the coolant in the first cooling loop 14 at a desired level. In this case, the second cooling loop 16 is omitted. It is to be understood that the heat exchanger 15 in FIG. 1 could also be an isolation, brazed plate heat exchanger disposed in an “open” cooling loop, as may be desired in some applications. That is to say, the second cooling loop 16 can be an open cooling loop in which coolant is drawn from and returned to a coolant reservoir, such as atmosphere, sea, etc.

When water is used as coolant in either of the above variants, since the water from the separators 95, 85, 100 is product water from the fuel cell, and hence pure and non-conductive, it can be collected and directed to the expansion tank 11 or 19, or coolant reservoir as coolant during the fuel cell operation.

Preferably, a flow regulating device 22 is disposed in the fuel supply line 20 upstream from the hydrogen humidifier 90. The flow regulating device or valve 22 permits the flow of hydrogen from the hydrogen source 21 to the fuel cell 12 in response to the pressure drop in the fuel supply line 20. The flow regulating device 22 may be a forward pressure regulator having a set point and that permits hydrogen to be supplied to the fuel cell 12 when the pressure in the fuel supply line 20 is below the set point due to the hydrogen consumption in the fuel cell 12. This forward pressure regulator avoids the need for an expensive mass flow controller and provides more rapid response and accurate flow control.

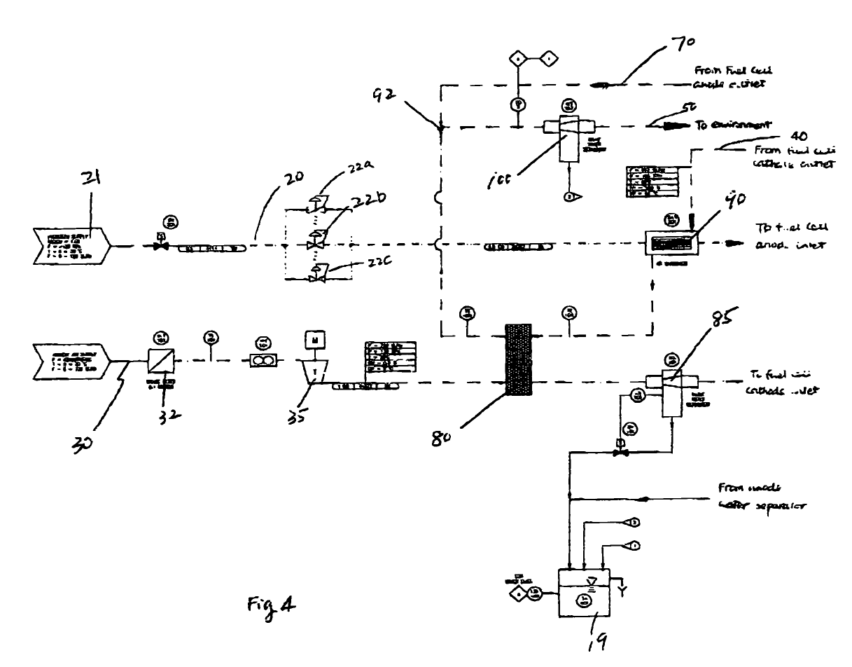

Referring to FIG. 4, to provide more control flexibility, the flow regulating means 22 may comprise a plurality of pre-set forward pressure regulators arranged in parallel with each forward pressure regulator having a different set point. For example, a first forward pressure regulator 22a may have a set point of 10 Psig, a second forward pressure regulator 22b may have a set point of 20 Psig, a third forward pressure regulator 22c may have a set point of 30 Psig, and so on. This makes it possible to operate the fuel cell 12 with fuel supplied at different pressures and different rates at each pressure, without the need of interrupting the operation and changing the set point of the forward pressure regulator.

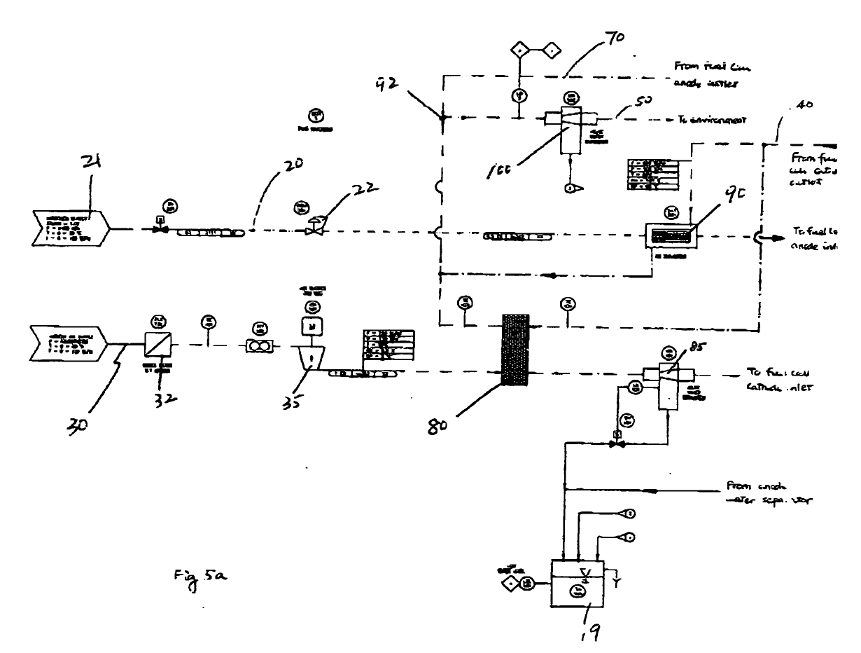

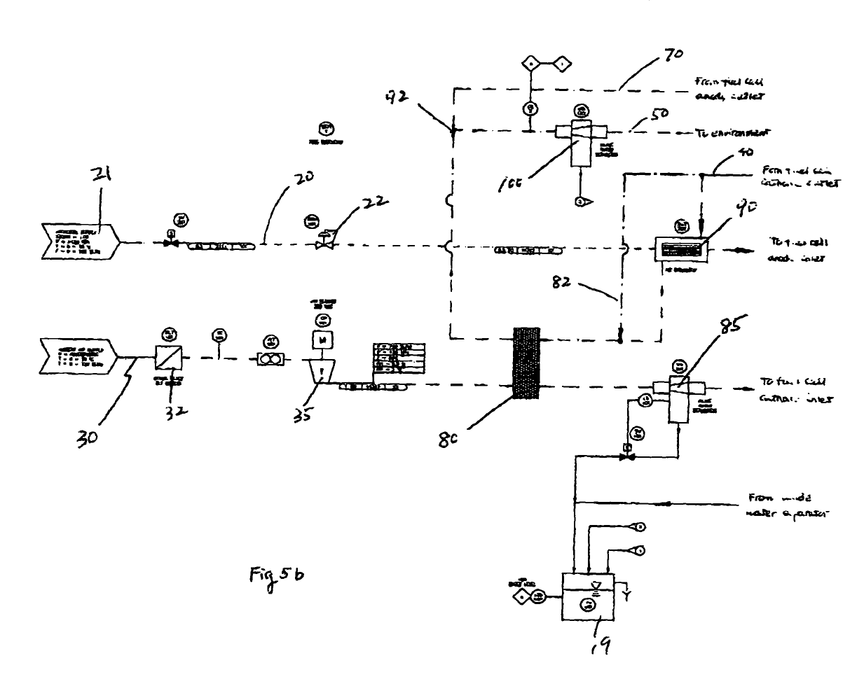

It is to be understood that although in this embodiment, the cathode exhaust is used to first humidify the incoming hydrogen and then the incoming air, this order is not essential. Instead, the cathode exhaust may be used to first humidify the incoming air and then the incoming hydrogen. Alternatively, as shown in FIG. 5a, the hydrogen humidifier 90 and the regenerative dryer 80 may be placed in parallel instead of series in the cathode exhaust recirculation line 60, so that the humidification of both hydrogen and air occurs simultaneously. Optionally, depending on the operation condition of the fuel cell 12, when the serial humidification is employed, a bypass line 82 may be further provided, as shown in FIG. 5b, to bypass the hydrogen humidifier 90 so that a portion of the cathod exhaust stream flows to the regenerative dryer 80 without passing through the hydrogen humidifier.

However, in practice it may be preferable to humidify the hydrogen stream first since anode dew point temperature is desired to be higher than the cathode dew point temperature because water is naturally transferred from the anode to the cathode in the fuel cell 12. The desired relative humidity of hydrogen is also often higher than that of air in the fuel cell 12 so that the fuel cell 12 will not be flooded. Therefore, it is preferable to use the cathode exhaust stream to exchange heat and humidity with incoming hydrogen stream first.

In known manner, various sensors can be provided for measuring parameters of the stream of fuel, oxidant and coolant, supplied to the fuel cell 12. Another aspect of the present invention relies on measuring just the temperature of the reactants and determining humidity from known temperature-humidity characteristics, i.e. without directly measuring humidity.

It can be appreciated that it is not essential to over saturate process gases, condense water out to obtain 100% relative humidity and then deliver the process gases at certain temperature to get desired relative humidity before they enter the fuel cell 12, as in the applicant's co-pending U.S. patent application Ser. No. 09/801,916. The present system is applicable to fuel cell systems where fuel and oxidant stream either have or do not have 100% relative humidity. An anode dew point heat exchanger and a cathode dew point heat exchanger may be provided to control the humidity of fuel and oxidant when the fuel cell 12 is not operable with fuel or oxidant having 100% relative humidity. However, this depends on the characteristic of the fuel cell 12, such as the operating condition of the proton exchange membrane.

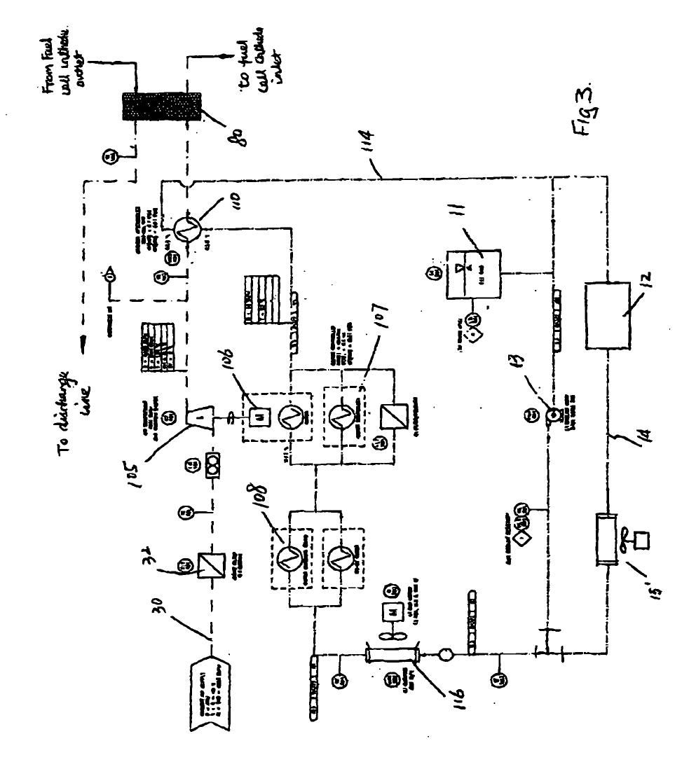

It is also to be understood that the foregoing fuel cell system op rates under ambient pressure or near ambient pressure. Referring to FIG. 3, there are illustrated cooling loops for use in third fuel cell system to which the present invention can be applied, that operates under high pressure, i.e. greater than atmospheric pressure.

In the third fuel cell system, similar components are indicated with same reference numbers, and for simplicity and brevity, the description of those components is not repeated.

In this third fuel cell system, a high pressure compressor 105 is provided in the oxidant supply line 30 upstream from the regenerative dryer 80 to pressurize the incoming air from the air filter 32. An after cooler heat exchanger 110 is provided between the compressor 105 and the regenerative dryer 80 to cool the compressed air having an elevated temperature. Hence, in addition to the first cooling loop 14 for the fuel cell 12, a third cooling loop 114 is provided including the after cooler heat exchanger 110 in the form of a water-water heat exchanger. The third cooling loop 114 may also run through respective heat exchangers for a compressor motor 106, a compressor motor controller 107 and a power switching board 108 for the compressor 105, for cooling these components. The coolant in both the first and third cooling loops 14 and 114 is driven by the first coolant pump 13. A radiator 116 with a powered fan is provided in the third cooling loop 114. This radiator 116 could optionally be replaced by a different heat exchange mechanism.

Regardless of the pressure under which the fuel cell system is operating, it is often preferable to balance the pressure of both fuel stream and oxidant stream supplied to the fuel cell 12. This ensures no significant pressure gradient exists within the fuel cell 12 and hence prevents damage of the fuel cell and prevents flow of reactants and coolants in undesired directions caused by pressure gradient. In addition, this also ensures proper stoichiometry of fuel and oxidant is supplied to the fuel cell 12 for reaction.

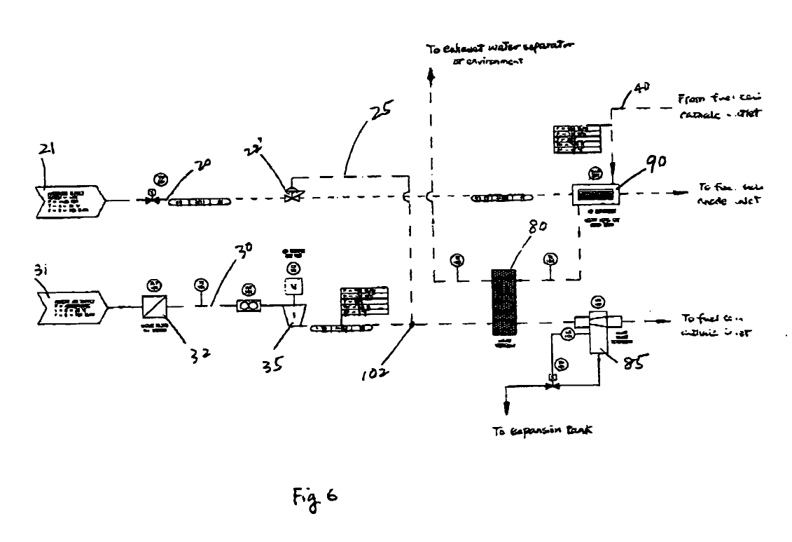

In the fuel cell systems illustrated, this is done by providing a balance pressure regulator 22′ and a pressure balancing line 25 between the fuel supply line 20 and the oxidant supply line 30, as shown in FIG. 6. The pressure balancing line 25 fluidly connects the balance pressure regulator 22′ disposed in th fuel supply line 20 upstream of the hydrogen humidifier 90, and a third joint 102 in the oxidant supply line 30 upstream of the regenerative dryer 80. The balance pressure regulator 22′ can still be a forward pressure regulator. However, it has to be adapted to work with two fluid stream and serves to balance the pressure between the two fluid streams. An example of this balance pressure regulator 22′ is disclosed in the applicant's co-pending U.S patent application Ser. No. 09/961,092, incorporated herein by reference. Generally, such balance pressure regulator 22′ regulates the hydrogen flow in response to the pressure of air stream introduced by the pressure balancing line 25, and achieves mechanical balance until the pressure of hydrogen flow is regulated to be equal to that of the air flow.

It can be appreciated that the pressure balancer can be disposed in oxidant supply line 30 so that the pressure of the air stream can be regulated in response to that of the hydrogen stream. However, in practice it is convenient to set pressure of air stream by choosing suitable speed or capacity of blower or compressor and to change the pressure of the hydrogen stream accordingly. Hence, it is preferred to make the pressure of the hydrogen stream track that of the air stream. In some systems, the pressure balance between two reactant incoming streams are set manually or by a controller. However, the present configuration automatically ensures the pressure balance.

All the water used to humidify the fuel and oxidant is generated by the fuel cell 12 itself. This reduces the weight and number of components in the system, making the overall system compact and highly efficient. The system is capable of rapid response to power demands. All these features are particularly desirable for vehicular applications.

As shown in FIG. 1, a fuel cell system typically requires at least one process fluid delivery device, for example, a blower or compressor 35, to supply process fluid to the fuel cell 12. In this figure, a blower is used to supply air into the fuel cell 12. It is to be understood that similar devices can also be used for supplying hydrogen into the fuel cell 12. The fuel cell 12 drives a load 200. In automobile applications, a fuel cell system is desired to provide instantaneous response to large load transient Sometimes, fuel cells may have unexpectedly large loads. For example, where an additional air conditioner is connected to a fuel cell system. In cases such as these, if the blower or compressor 35 is still operating at the same level as when the fuel cell was in the lower operating range, then there is a high risk that the fuel cell will be damaged. Therefore, it is desirable for the fuel cell system to be prepared for such large load transient.

Referring again to FIG. 1b, the fuel cell system includes a controller 300 in accordance with an aspect of the invention. The controller 300 is a central controller that controls various components of fuel cell system, such as coolant pump, blowers, pressure regulators. Optionally, controller 300 may be replaced with a local controller that only controls the operation of the process fluid delivery device 35. In anticipation of a large transient change in the load 200, the controller 300 will control the blower 35 to operate at a higher rate in order to make preparation for an abrupt change in load 200. Then when the load 200 changes, the fuel cell system is able to support such load 200.

In normal, stable operation, the controller 300 controls the operating level of the blower 35 based on the monitored values of the flow and pressure of the fluids that the blower 35 provides to the fuel cell 12, as well as based on the current that the load 200 draws from the fuel cell 12, which current is measured by a load meter such as an amperemeter 250 shown in FIG. 1. When a sudden change in load 200 is anticipated, a user can send a signal from a user input module 260 to the controller 300 that overrides the current controlled operating level of the blower 35. Then the controller 300 controls the blower to increase speed, preferably to its maximum speed, so that an increased amount of process fluid is supplied to the fuel cell 12 to prepare the same for a large transient change in the load 200. Optionally, a user through the controller 300 may control the blower 35 to run at a number of different lev Is, or may control the blower 35 to vary its level of op ration along a continuum.

The controller 300 senses both the change in load current and the load current itself. When the rate at which the load 200 changes is beyond a certain level, or the load 200 itself has changed beyond a certain level, the controller 300 overrides the current operating level of the blower 35 and controls the blower 35 to operate at a higher speed, preferably its maximum speed Such a threshold of rate of change of the load or threshold of the load level can be predetermined and stored in the controller 300. Optionally, the controller 300 may control the blower 35 to run at a number of different levels, or may control the blower 35 to vary its level of operation along a continuum depending on the current drawn by the load or the rate of change in the current drawn by the load

Referring to FIG. 1b, there is illustrated in a block diagram the controller 300. As shown, the controller 300 comprises a linkage module 306 connecting the controller 300 to the blower 35 and amperemeter 250, as well as a storage module 302 and a logic module 308. The logic module 308 is linked to user input module 260

As described above, in operation the controller 300 receives a signal from the amperemeter 250. This signal includes a first value, representing the current in the amperemeter, and a second value, representing the rate of change of the current in the amperemeter 250. Stored in the storage module 302 are a first value threshold and a second value threshold. Logic module 308 compares the first value and second value from the amperemeter 250 with the first value threshold and second value threshold respectively. If either the first value exceeds the first value threshold, or the second value exceeds the second value threshold, then the linkage module will instruct blower 35 to operate at a higher level—optionally, at its highest operating level. Alternatively, if both the first value and the second value are below the first value threshold and second value threshold respectively, the operating level of blow r 35 will not be affected

Logic module 308 is also connected to user input module 260. Optionally, a user, anticipating a massive increase in load, may send an overriding signal to the logic module 306, instructing the controller 300 to increase the operating level of the blower 35. By providing a user input module 206, it is possible to bypass the normal feedback control provided via amperemeter 250 and linkage module 306 to more quickly increase the operating level of the blower 35.

The present invention has many advantages over the existing fuel cell system. By overriding current operating values of the process fluid, the fuel cell is able to handle fast load transients and large step load transients. This also considerably reduces the risk of damaging the fuel cell due to large or abrupt change in load.

While the above description constitutes the preferred embodiments, it will be appreciated that the present invention is susceptible to modification and change without departing from the fair meaning of the proper scope of the accompanying claims. For example, the present invention might have applicability in various types of fuel cells, which include but are not limited to, solid oxide, alkaline, molten-carbonate, and phosphoric acid. In particular, the present invention may be applied to fuel cells which operate at much higher temperatures. As will be appreciated by those skilled in the art, the requirement for humidification is very dependent on the electrolyte used and also the temperature and pressure of operation of the fuel cell. Accordingly, it will be understood that the present invention may not be applicable to many types of fuel cells.

1. A fuel cell system, comprising:
(a) a fuel cell for driving a load,
(b) a first process fluid delivery device for supplying a first process fluid to the fuel cell;
(c) a controller for controlling an operation rate of at least the first process fluid delivery device; and
(d) a signal source external to the controller, for providing a signal to the controller to change the operation rate of at least the first process fluid delivery device.

2. A fuel cell system as claimed in claim 1, wherein the controller is operable to increase the operation of the first process fluid delivery device to a maximum capacity based on the signal.

3. A fuel cell system as claimed in claim 1, wherein the signal source comprises a user input module.

4. A fuel cell system as claimed in claim 1, wherein the signal source comprises a load meter for sensing at least one of a first value representing a current in a load circuit and a second value representing a rate at which the current changes in the load circuit;
wherein the controller is operable to increase the operation rate of the first process fluid delivery device based on at least one of the first value and the second value.

5. A fuel cell system as claimed in claim 4, wherein the controller comprises a processor for comparing at least one of the first value with a first value threshold and a second value with a second value threshold, and for controlling the controller to increase the operation rate of the first process fluid delivery device to its maximum capacity when at least one of the first value exceeds the first value threshold and the second value exceeds the second value threshold.

6. The fuel cell system as claimed in claim 4 wherein the controller is operable to continuously vary the operation rate of the first process fluid delivery device based on at least one of the first value and the second value.

7. The fuel cell system as claimed in claim 4 wherein the controller is operable to switch the operation rate of the first process fluid delivery device between a plurality of levels based on at least one of the first value and the second value.

8. The fuel cell system as claimed in claim 4 wherein
the load meter is operable to read the first value; and,
the controller is operable to change the operation rate of the first process fluid delivery device based on changes in the first value.

9. The fuel cell system as claimed in claim 4 wherein
the load meter is operable to read the second value; and,
the controller is operable to change the operation rate of the first process fluid delivery device based on changes in the second value.

10. A method of operating a fuel cell system, comprising
(a) supplying a process fluid to a fuel cell at a supply rate;
(b) driving a load using the fuel cell;
(c) measuring at least one of a first value representing a current in the load and a second value representing a rate of change of the current in the load;
(d) changing the supply rat based on at least one of the first value and the second value.
(e) anticipating a change in at least one of the first and second values beyond the respective predetermined value and changing the supply rate in response thereto.

11. A method of operating a fuel cell system as claimed in claim 10, wherein step (a) comprises providing a process fluid delivery device to supply the process fluid to the fuel cell at the supply rate, and step (d) comprises providing a controller for controlling the process fluid delivery device to change the supply rate based on at least one of the first value and the second value rate.

12. A method of operating a fuel cell system as claimed in claim 10, wherein step (d) comprises increasing the supply rate of the process fluid to a maximum capacity of the process fluid delivery device when at least one of the first value exceeds a first value threshold and the second value exceeds a second value threshold.

13. A method of operating a fuel cell system as claimed in claim 10, wherein step (c) comprises reading a current flowing through the load to determine at least one of the first value and the second value.

14. The method as claimed in claim 10 wherein step (d) comprises continuously varying the operation rate of the first process fluid delivery device based on at least one of the first value and the second value.

15. The method as claimed in claim 10 wherein step (d) comprises switching the operation rate of the first process fluid delivery device between a plurality of levels based on at least one of the first value and the second value.

16. The method as claimed in claim 10 wherein
step (c) comprises measuring the first value; and,
step (d) comprises changing the operation rate of the first process fluid delivery device based on changes in the first value.

17. The method as claimed in claim 10 wherein
step (c) comprises measuring the second value; and,
step (d) comprises changing the operation rate of the first process fluid delivery device based on changes in the second value.
